(19) United States
(12) Patent Application Publication
(10) Pub. No.: US 2006/0285340 A1
(43) Pub. Date: Dec. 21, 2006

(54) Fusible link for diffuser

(75) Inventor: Peter F. Thornton JR., Westmont, IL (US)

Correspondence Address: BANNER & WITCOFF, LTD., TEN SOUTH WACKER DRIVE, SUITE 3000, CHICAGO, IL, 60606, US

(73) Assignee: Focal Point LLC, Chicago, IL (US)

(21) Appl. No.: 11/155,814

(22) Filed: Jun. 17, 2005

(51) Int. Cl. F21V 17/00

(52) U.S. Cl. 362/455; 362/294; 362/306; 362/307; 362/456

(57) ABSTRACT

A recessed luminaire includes a housing with one or more vents. The one or more vents may be coupled to a ventilation system so that the luminaires can provide ventilation as well as illumination. The housing supports a potentially flammable diffuser with one or more fusible links. When subjected to elevated temperatures, at least a portion of the one or more fusible links will soften so the diffuser may drop down.

### BACKGROUND OF THE INVENTION

1. Field of the Invention

The present invention relates to a luminaire, more specifically to a vented luminaire with a potentially flammable diffuser.

2. Description of Related Art

Luminaires are commonly used in office buildings and the like. The luminaire may be a recessed luminaire that is mounted so as to be flush with the ceiling and provides the needed illumination. To improve the light distribution pattern, most luminaires include a diffuser. The diffuser acts to modify the light distribution of the light bulbs and helps prevent the formation of hot spots and undesirable glare that would be distracting to the occupants working in the vicinity of the luminaire. While the diffuser could be made of a variety of materials, the diffuser may be made of a perforated basket with a translucent plastic inlay. Plastic is light as compared to glass, is unlikely to shatter into sharp pieces when dropped, and can be readily made with desired properties so as to provide the type of light transmission that corresponds to the design requirements of the luminaire.

As is known, many office buildings have ceilings that use what is known as a drop ceiling design. The drop ceiling may provide a space between the visible ceiling and a structurally supportive ceiling and this space may be referred to as a plenum. The use of drop ceilings allows electrical and ventilation systems to be run in the plenum so that an electrical and a ventilation system can direct electricity and air where needed. Some buildings also use the plenum as a return air source for the ventilation system. While the primary function of a luminaire is to provide light, as most rooms include at least one luminaire, the luminaires can also provide ventilation. To do so, the luminaire may be coupled to the ventilation system so that air can enter or exit the ventilation system through the one or more vents in the luminaire. The coupling may simply be a vent that provides a passageway so as to fluidly connect the room to the plenum and may also be a connection between a booted luminaire and a duct that is connected to the ventilation system. Thus, the luminaire can provide light and also provide an air return and/or an air supply for the room. This has the benefit of minimizing the need for additional vents in the ceiling and therefore can provide a cleaner and more attractive appearance.

One potential drawback with the use of plastic diffusers, or other materials similar to plastic, is that they are flammable. Generally speaking, plastic will burn when subjected to sufficient heat or flame. The response of most plastics varies from sustaining the flame once the plastic is ignited to merely burning while the flame is applied, however both examples are considered flammable for the purpose of this invention. Thus, the use of a plastic diffuser is potentially problematic because, in the event of a fire, the diffuser may burn even if the plastic material does not sustain the fire.

The problem may become exacerbated when vented luminaires with potentially flammable diffusers are connected to the ventilation system. In addition, as the luminaire is often recessed, the provision of fire extinguishing equipment, such as sprinklers in the ceiling, may not direct fire suppressing materials onto the luminaire. In the event of a fire, the diffuser may burn and, because of the close proximity to the vents in the luminaire, the burning diffuser may cause smoke to enter the ventilation system or spread fire to adjacent luminaires. To address these potentially life threatening problems, the Underwriters Laboratory provides standard UL 1598. This standard requires, among other things, that a flammable diffuser drop away from the luminaire in the event of a fire. To ensure the plastic diffuser drops away, one method is to use a deformable support made of two different metals. When subjected to heat, the different rates of expansion of the two different metals causes the support to deform and allows the diffuser to drop. Unfortunately, such a method is unduly restrictive because it limits how the support can hold the diffuser. Therefore, an improvement is needed so that the support holding the diffuser can be designed as needed while still meeting the requirements of UL 1598.

### BRIEF SUMMARY OF THE INVENTION

In an aspect of the present invention, an air handling luminaire includes a potentially flammable diffuser supported at both ends by fusible links, the links supported by a housing. When subjected to sufficient heat, at least a portion of the fusible links will soften and allow the diffuser to drop away. In an embodiment, the diffuser may include a plastic material and be supported by four fusible links.

### BRIEF DESCRIPTION OF THE DRAWINGS

The present invention is illustrated by way of example and not limited in the accompanying figures in which like reference numerals indicate similar elements and in which:

FIG. 1 illustrates a cross-sectional view of an installed luminaire according to an aspect of the present invention.

FIG. 2 is an isometric view of an illustrative embodiment of the assembled luminaire according to an aspect of the present invention.

FIG. 3 is an illustration of a cut-away view taken along the line 2 in FIG. 1.

FIG. 4 is an isometric view of an illustrative embodiment of a fusible link according to an aspect of the present invention.

FIG. 5 is an illustration of a side view of the fusible link shown in FIG. 3.

FIG. 6 is a view of a portion of a fusible link according to an aspect of the present invention.

### DETAILED DESCRIPTION OF THE INVENTION

Luminaires for use in buildings, such as office buildings, have a number of requirements. The luminaires preferably are both attractive and functional. Furthermore, to save money it is beneficial to maximize the functionality of the luminaire by using it as part of the ventilation system. In addition, the luminaires may also protect against the possibility of an emergency, such as a fire.

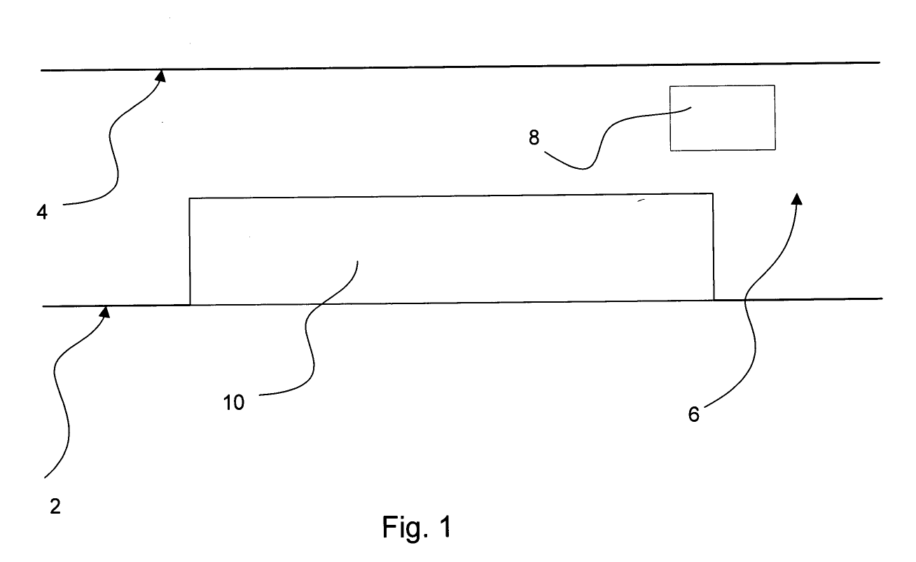

FIG. 1 illustrates an embodiment of an installed luminaire. A drop ceiling 2 is suspended below a support ceiling 4. The area between the drop ceiling 2 and the support ceiling 4 is a plenum 6. A ventilation system 8 is provided in the plenum 6. In addition, the cross-section of a luminaire 10 is also depicted. The ratios and dimensions of the different components may vary depending on the installation. As depicted, the luminaire 10 is shown as mounted flush with the drop ceiling 2 but a flush mounting, while aesthetically beneficial, is not required. It should be noted that additional components, such as wires and ducts (not shown), may also be routed in the plenum 6.

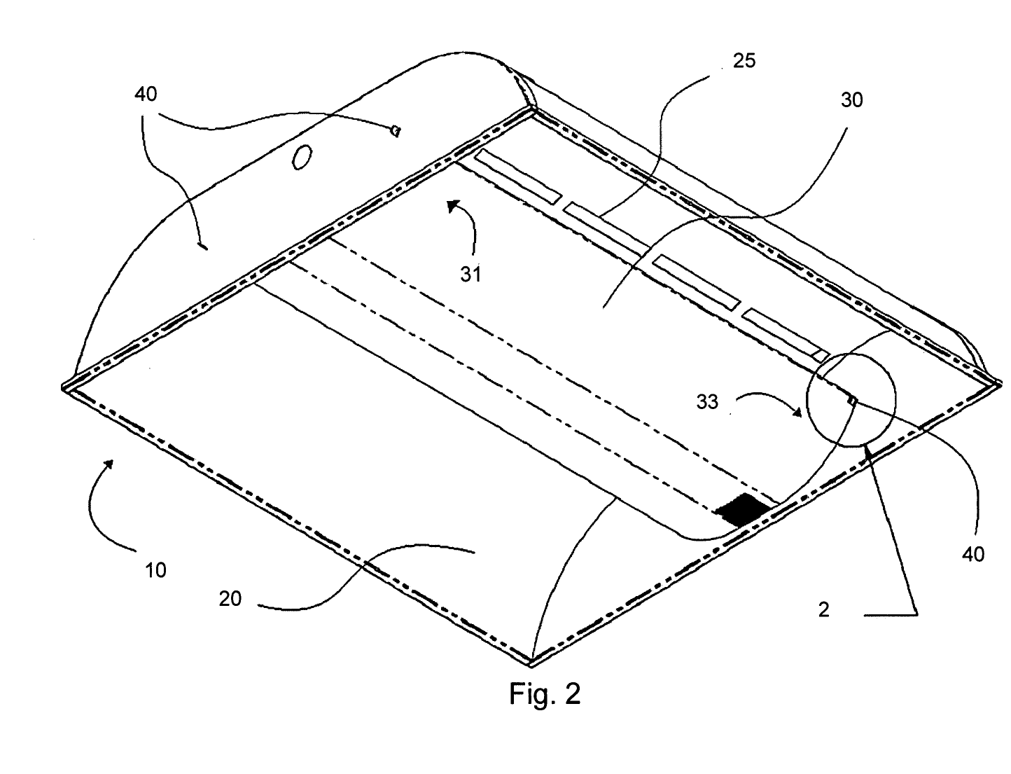

FIG. 2 is an illustration of an exemplary embodiment of the luminaire 10. As depicted, the luminaire 10 comprises a housing 20 (which may also be referred to as a structural reflector) and a diffuser 30. The housing 20 may include one or more vents 25. The vent 25 provides a passageway for air flow and may be used to couple the housing 20 to a ventilation system (not shown). In an embodiment, the vent will allow the passage of air between the area below and above the drop ceiling (i.e. between the room and plenum).

The housing 20 may be made out of a 20-gauge cold rolled steel alloy and may be coated with a white reflective paint such as a polyester powder coat applied over a 5-stage process with a resultant reflectance of 94% or more. Other colors, such as silver, may also be provided.

In an illustrative embodiment, the diffuser 30 includes a perforated basket (not shown) along with a frosted acrylic configured to minimize visibility of the underlying linear light sources while maximizing the efficiency of the luminaire. In an embodiment, the diffuser 30 may include a perforated metal basket with a plastic inlay (not shown), which may be configured to have the desired light transmission properties corresponding to the configuration of the luminaire. While the perforated basket (which may be made of metal) aids in supporting the plastic portion of the diffuser 30, in an embodiment the perforated basket may be omitted and a sufficiently robust plastic material may be used instead.

The diffuser 30 is supported by one or more fusible links 40 mounted near the corners of the diffuser 30. When sufficient heat is applied to the one or more fusible links 40, the diffuser can drop away from the housing 20 and the one or more vents 25.

It should be noted that, depending on how the diffuser 30 and the means for supporting it are configured, one fusible link 40 may be sufficient to support the diffuser 30. For example, if the diffuser 30 was primarily supported by the fusible link 40 but also was partially supported by non-fusible links (not shown), when the fusible link 40 softened the diffuser 30 could still drop.

As can be appreciated, various known electrical components typically used in luminaires are required. These components are known in the art and, therefore, will not be described. The housing 20 may additionally include one or more holes suitable for accepting wires and/or allowing various electrical components to be installed within or connected (either directly or indirectly) to the housing in a known manner.

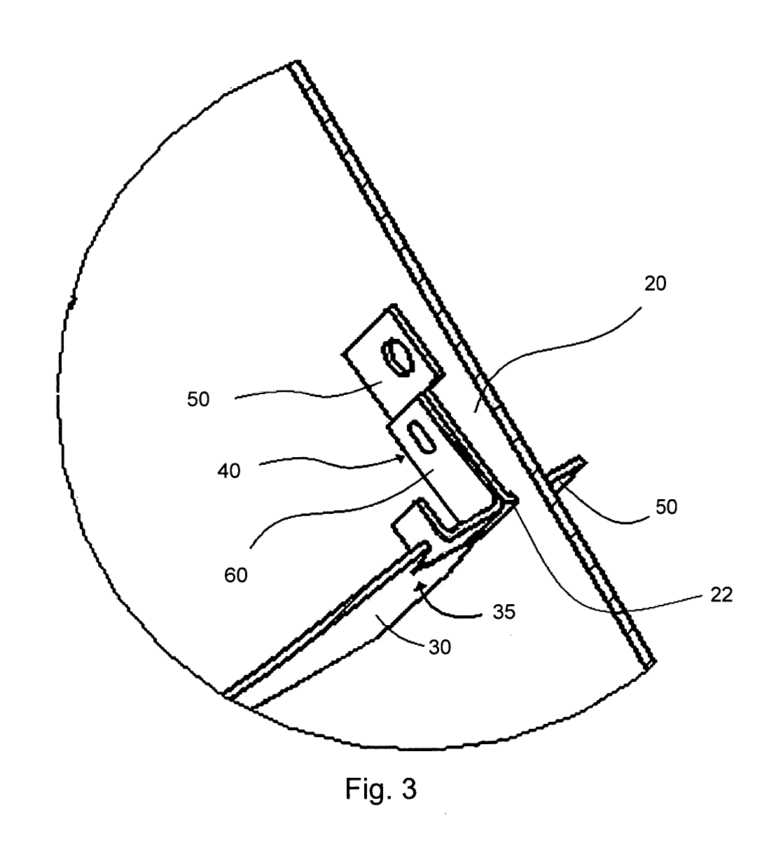

FIG. 3 is an illustration of a cut-away view of a portion of FIG. 2, taken along the line 2. An embodiment of a fusible link 40 is illustrated mounted to the housing 20 as well as being mounted to the diffuser 30. As depicted, the fusible link 40 includes a first bracket 50 and a second bracket 60 that are joined together. It should be noted that the mounting, while depicted as direct, may also be indirect through the use of additional components between the fusible link 40 and either or both of the housing 20 and the diffuser 30. Mounting directly, however, has the advantage of a relatively simple installation procedure.

As depicted, the first bracket 50 is mounted to the housing 20. The mounting may include known methods of mounting, such as interlocking components, fasteners or adhesives, to name a few. As depicted, the first bracket 50 is inserted into a hole 22 in the housing 20 and the second bracket 60 is inserted into a hole 35 in the diffuser 30. In this manner, the first bracket 50 and the second bracket 60 will securely support the diffuser 30. A potential benefit of providing the hole 22 in the housing 20 is that the hole 22 can be used as a positioning feature for the installation of the bracket 50 so as to aid in the assembly of the luminaire 10 (FIG. 2). A potential benefit of providing the hole 35 in the diffuser 30 is that with the proper configuration of the second bracket 60, the bracket 60 will support the diffuser 30 without the use of additional fasteners. This can save time and cost along with improving the robustness of the overall design.

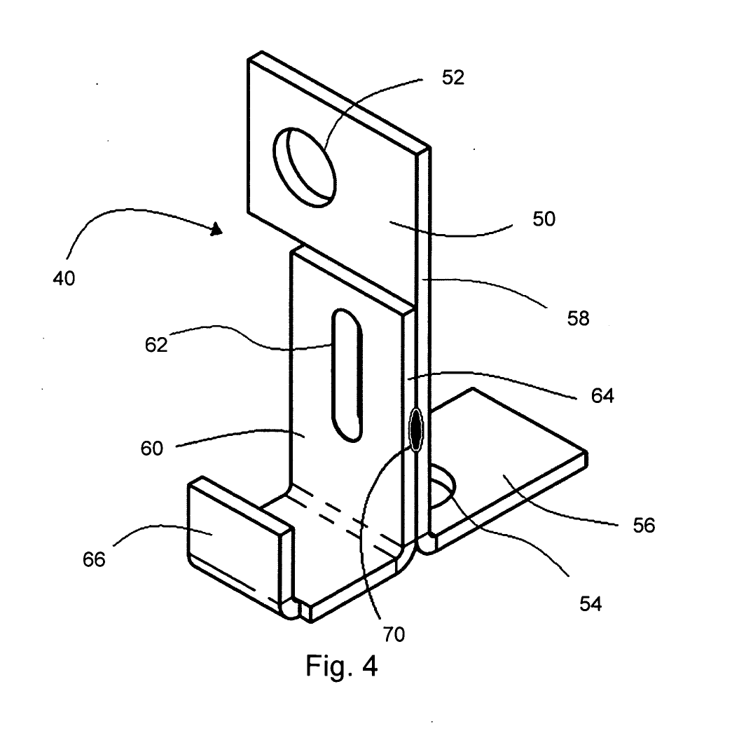

As is known, office spaces are intended to be kept within a range of temperatures. When the temperature significantly exceeds the expected range of temperatures, the temperature may be considered elevated. For example, but without limitation, a temperature of 202 degrees Fahrenheit may be considered elevated. When subjected to the appropriate elevated temperature, a low temperature compound, such as a low temperature compound 70 (FIG. 4) that holds the first and second brackets 50, 60 together, will soften and allow the two bracket 50, 60 to become separated. As the diffuser 30 may be supported by one or more fusible links 40, when sufficient heat is applied to the one or more fusible links 40 in particular, the low temperature compound 70 of the one or more fusible links 40 will soften and the diffuser 30 may drop away from the housing 20. Of course, the fusible link 40 may also be formed of a low temperature compound that will soften and allow the diffuser 30 to drop away.

It should be noted that the term softening means that at least part of the material supporting the diffuser 30 plastically yields, melts, gives way, or releases in some other manner. In the case of a low temperature compound 70 made of a lead-based solder, for example, the softening may be referred to as melting. For some low temperature compounds, the softening may be relatively abrupt while in other low temperature compounds, the softening may be more gradual and may even occur over a range of temperatures.

Referring back to FIG. 2, the diffuser 30, which includes a first end 31 and a second end 33, is supported at both ends 31, 33 by the one or more fusible links 40. While not required, this allows the diffuser 30 to drop away if either end 31, 33 is subjected to sufficient heat.

FIG. 4 shows an illustrative embodiment of the fusible link 40. The first bracket 50 includes a mounting hole 52 and a retaining hole 54 on an arm 56. Referring back to FIG. 3, the arm 56 is inserted in a positioning hole 22 in the housing 20. The bracket 50 may then be mounted to the housing 20 by use of a fastener (not shown) through the mounting hole 52 so as to hold the first bracket 50 in position. To more rigidly mount the first bracket 50 to the housing 20, a retainer may be inserted into the retaining hole 54 so as to prevent the arm 56 from exiting the hole 22.

The low temperature compound 70 is provided and joins the edges 58 and 64 of the brackets 50 and 60, respectively. The low temperature compound 70 may be a low temperature solder configured to hold the first and second brackets 50, 60 together. For example, the low temperature compound 70 may be a solder alloy having a compensation of 52% Bismuth, 30% Lead and 18% Tin. Such a solder would typically have a melting point around 202 degrees Fahrenheit or about 94.4 degrees Celsius. Naturally, a low temperature solder could be configured to melt at a higher temperature such as 220 or 300 degrees Fahrenheit or even some temperature below 200 degrees Fahrenheit. Thus, the term low temperature refers to a temperature below the burning point of the diffuser 30. Thus, depending on the material properties of the diffuser 30, the composition of the low temperature compound 70 can vary as desired.

While depicted as provided on the edge of the fusible link 40, it may be useful to place the low temperature compound 70 within a fusing hole 62 of bracket 60. The fusing hole 62, which may be shaped as depicted or of any other shape such as triangular or some irregular shape, can provide a mating surface area that helps allow the two brackets 50, 60 to become fastened together. Furthermore, locating the low temperature compound 70 near the middle of the mating surfaces of the bracket 50 and bracket 60 helps minimize unwanted stresses on the low temperature compound 70.

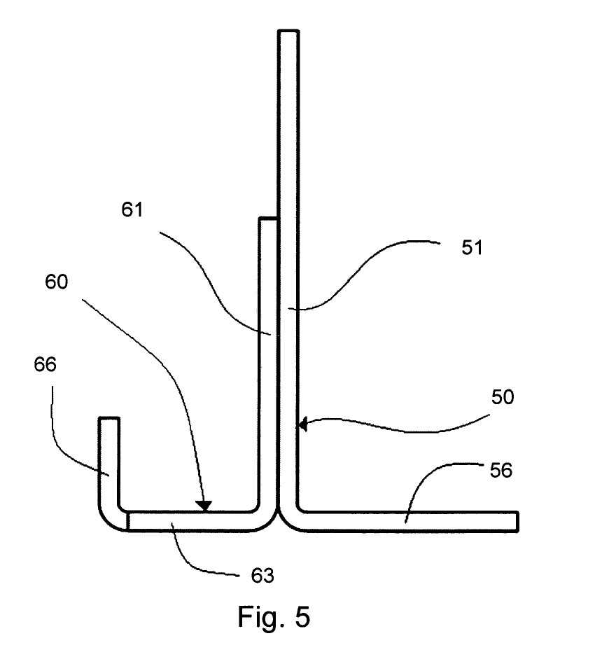

Turning to FIG. 5, a side view of the embodiment of the fusible link 40 depicted in FIG. 4 is illustrated. As can be appreciated, the bracket 50 has a leg 51 that connects to the arm 56. The bracket 60 includes a leg 61 that is connected to an arm 66 via a base 63. The bracket 60 is this depicted as having a “J” shape. Referring back to FIG. 3, as can be appreciated, the arm 66 is substantially inserted into the diffuser 30. While not required, this shape helps ensure the bracket 60 reliably supports the diffuser 30 without concern that the diffuser 30 might accidentally drop due to vibrations or the like. It should be noted that the bracket 60 may have more or less features as desired.

It may be useful to configure the fusible link 40 so that it blends in with the housing 20. In an illustrative embodiment, both brackets 50, 60 may be formed out of 22-gauge cold rolled steel. Once the two brackets are combined together by the low temperature compound 70 (not shown), the fusible link 40 may be painted white. For example, the fusible link 40 may be spray painted or dipped. Of course, depending on the materials and the design of the fusible link 40, the painting step may not be necessary.

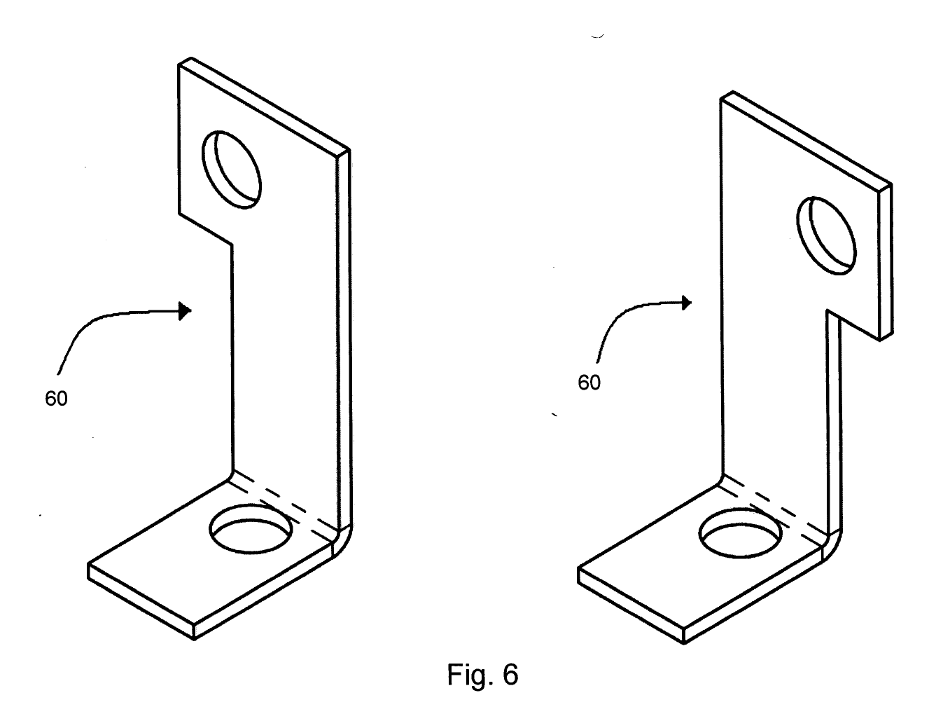

Turning to FIG. 6, two examples of the bracket 60 are illustrated. As depicted, the two brackets 60 are configured to mount to the housing 20 on opposite sides of the diffuser 30. Thus, as can be appreciated from FIG. 6, the bracket 60 may be provided in different configurations depending on how the bracket 60 is mounted to the housing 20 (FIG. 3). Therefore, there is considerable flexibility in the design of both the bracket 60 and the bracket 50.

It should be noted that numerous other configuration are possible. Thus, the design of the fusible link 40 is only limited by the packaging constraints of the luminaire 10 (FIG. 2). In addition, the first bracket 50 could be omitted and the second bracket 60 could be joined to the housing 20 by the low temperature compound 70. Furthermore, while FIG. 4 depicts a small portion of the fusible link 40 including the low temperature compound 70, a greater portion or even the entire fusible link 40 may be formed of the low temperature compound 70. For example, the entire fusible link 40 could soften when subjected to an elevated temperature. Accordingly, the low temperature compound 70 could be, for example but without limitation, a heat sensitive adhesive or a plastic or some other suitable temperature sensitive material that will soften when exposed to an elevated temperature. As can be appreciated, the choice of low temperature compound 70 will depend somewhat on the portion of the fusible link 40 the low temperature compound 70 comprises.

The present invention has been described in terms of preferred and exemplary embodiments thereof. Numerous other embodiments, modifications and variations within the scope and spirit of the appended claims will occur to persons of ordinary skill in the art from a review of this disclosure.

We claim:

1. A fusible link for releaseably supporting a diffuser to a luminaire housing, the fusible link comprising:
a first bracket configured to engage the housing;
a second bracket configured to engage the diffuser; and
a low temperature compound, the low temperature compound joining the first and second bracket together.

2. The fusible link of claim 1, wherein the low temperature compound is a lead-based alloy configured to soften at about 202 degrees Fahrenheit.

3. The fusible link of claim 1, wherein the low temperature compound is configured to soften at a temperature below 300 degrees Fahrenheit.

4. The fusible link of claim 1, wherein the second bracket includes a fusing hole.

5. The fusible link of claim 1, wherein the second bracket includes an arm, the arm configured so as to be inserted, in operation, into a hole in the diffuser.

6. An air handling luminaire, comprising:
a housing, the housing having at least one vent;
a diffuser configured to modify the light pattern emitted from the housing, the diffuser have a first end and a second end; and
a fusible link supporting the first end of the diffuser, the fusible link comprising a low temperature compound, the low temperature compound configured to soften in response to an elevated temperature.

7. The air handling luminaire of claim 6, wherein the fusible link is a first fusible link and the luminaire further comprises a second fusible link, wherein the second end of the diffuser is supported by the second fusible link.

8. The air handling luminaire of claim 6, wherein the fusible link comprises a first bracket mounted to the housing and a second bracket mounted to the diffuser, wherein the first and second bracket are joined by the low temperature compound.

9. The air handling luminaire of claim 8, wherein the low temperature compound comprises a lead-based solder.

10. The air handling luminaire of claim 9, wherein the lead-based solder is about 52 percent Bismuth, about 30 percent Lead and about 18 percent Tin.

11. The air handling luminaire of claim 9, wherein the second bracket includes a fusing hole.

12. The air handling luminaire of claim 8, wherein the housing includes a hole and a portion of the first bracket is inserted in the hole in the housing.

13. The air handling luminaire of claim 8, wherein the diffuser includes a hole and a portion of the second bracket is inserted in the hole.

14. The air handling luminaire of claim 13, wherein the second bracket includes an arm and a portion of the arm extends through the hole in the diffuser.

15. A recessed luminaire configured to have a light distribution, the recessed luminaire comprising:
a housing, the housing having a vent, the vent configured to provide a passageway for air flow;
a first fusible link mounted to the housing, the first fusible links comprising a first low temperature compound, the first low temperature compound configured to soften in response to an elevated temperature;
a second fusible link mounted to the housing, the second fusible links comprising a second low temperature compound, the second low temperature compound configured to soften in response to an elevated temperature; and
a diffuser for modifying the light distribution of the luminaire, the diffuser supported by the first and second fusible links.

16. The recessed luminaire of claim 15, wherein the vent is occluded from view.

17. The recessed luminaire of claim 15, wherein the diffuser includes a first end and a second end, wherein the first end of the diffuser is supported by the first fusible link and the second end is supported by the second fusible link.

18. The recessed luminaire of claim 16, wherein the first fusible link comprises a first bracket mounted to the housing and a second bracket mounted to the diffuser, wherein the first bracket and second bracket are joined by the first low temperature compound.

19. The recessed luminaire of claim 18, wherein the first low temperature compound is a lead-based solder.

20. The recessed luminaire of claim 18, wherein the diffuser includes a hole, wherein the second bracket includes an arm that is inserted into the hole in the diffuser, and wherein the vent is configured to couple the luminaire, in operation, with a ventilation system.
